(19) United States
(12) Patent Application Publication
(10) Pub. No.: US 2013/0088107 A1
(43) Pub. Date: Apr. 11, 2013

(54) SUPPRESSION COIL

(71) Applicant: GRUNDFOS HOLDINGS A/S, Bjerringbro (DK)

(72) Inventor: Thomas HOLMGAARD, Bjerringbro (DK)

(73) Assignee: GRUNDFOS HOLDINGS A/S, Bjerringbro (DK)

(21) Appl. No.: 13/645,978

(22) Filed: Oct. 5, 2012

(30) Foreign Application Priority Data
Oct. 7, 2011 (EP) 11 184 362.9

(51) Int. Cl. H02K 11/02; H01F 27/02

(52) U.S. Cl. 310/72; 336/90

(57) ABSTRACT

A suppression coil (C) has an annular coil core (10) of a magnetic material and at least one winding (20) which is wound around the coil core (10). The coil core (10) is thereby arranged in the inside of an annular, inherently stable housing (30). A pump assembly is provided with such a suppression coil.

### CROSS REFERENCE TO RELATED APPLICATIONS

This application claims the benefit of priority under 35 U.S.C. §119 of European Patent Application EP 11 184 362.9 filed Oct. 7, 2011, the entire contents of which are incorporated herein by reference.

### FIELD OF THE INVENTION

The invention relates to a suppression coil with an annular coil core of a magnetic material and at least one winding which is wound around the coil core, as well as to a pump assembly with such a suppression coil.

### BACKGROUND OF THE INVENTION

The geometric dimensions of a ferromagnetic body change under the influence of a magnetic field. The compression of the structure of a ferromagnetic material is responsible for this effect called magnetostriction.

These materials may be seen as an entirety of small material portions which act like permanent magnets. If the material is not magnetised, these small portions are distributed randomly in space. If on the other hand the material is magnetised, all portions align their axis in the same direction

Changes of the magnetic characteristics of an object may occur under the influence of mechanical forces and this is called the Villari effect. This effect may also be observed on a magnet coil when this is subjected to a mechanical loading. Since the magnetic characteristics change, the function of an electrical component or apparatus which comprises this coil may be completely eliminated or at least compromised. This is particularly true in the case of a suppression coil which, connected in the mains supply lead of a motor, has a small reactive impedance with regard to the mains frequency, but a large reactive impedance for high-frequency disturbances, by way of which the penetration of such disturbances into the mains is prevented.

### SUMMARY OF THE INVENTION

It is an object of the present invention to solve the above problems and to provide a suppression coil with which a Villari effect may be reliably ruled out, i.e. its electromagnetic characteristics remain unchanged even under mechanical loading. This suppression coil should moreover be constructed in a simple manner, able to be easily manufactured and inexpensive.

The suppression coil according to the invention comprises a coil core and a winding which is wound around this, wherein the coil core is arranged in the inside of an annular, inherently stable housing. This at the same time simple as well as extremely effective encasing of the core protects this against external loads which are accommodated by the housing. A corresponding air gap between the housing and the core may thereby yet provide an additional safety factor. In any case, however, the suppression coil according to the invention may be freely placed in a component or apparatus, and specifically independently of the respective mechanical loads which are to be expected at the location of installation. The simple and at the same time also surprisingly effective construction of the suppression coil according to the invention therefore at the same time permits its application in a particularly flexible manner.

In a preferred embodiment of the suppression coil according to the invention, at least one winding of the coil is wound around the housing at the outside. With this, not only is a particularly effective protection of its core possible, but also a cooling of the winding is ensured from the outside.

The housing is preferably manufactured of an electrical insulating material, preferably of plastic. Thus for example one may make do without a normally necessary isolation of the winding with respect to the core. Such a housing at the same time may be easily manufactured, e.g. with the injection molding method.

A particularly simple encasing of the core of the coil arises if the housing is designed in a closed manner, for which the core e.g. is peripherally injected in one manufacturing step. Moreover, the closed housing has the advantage that no foreign matter may enter into the inside of the housing.

A preferred alternative design of the housing moreover entails this being composed of two shell bodies which are connected to one another and which are designed and dimensioned such that they enclose a cavity, in which the annular coil core is arranged. This design, apart from simple compositions of the housing, also permits the dimensioning of the cavity such that an air gap remains between the core and the housing, in order to accommodate possible deformations of the housing under mechanical load. A quick and simple connection of both shell bodies to one another is thereby preferably effected via a plug-in connection, in particular a locking connection.

A particularly simple and stable construction of the housing results when at least one of the shell bodies comprises a cylindrical side wall which surrounds the coil core on its inner periphery or its outer periphery, as well as a base on one axial end of the side wall, said base extending transversely to the side wall. Alternatively or additionally, at least one of the shell bodies may however also be designed in an annular manner with two cylindrical side walls radially distanced to one another and an with annular base connecting the two side walls at an axial end, wherein the cavity is formed between the side walls, in which cavity the coil core is arranged. The stability of the housing may be yet further increased if each of the two shell bodies comprises at least one cylindrical side wall and the two side walls overlap one another at one side of the coil core. Thereby, a particularly simple and reliable assembly of both shell bodies may be assisted, if these comprise projections and recesses designed complementarily to one another, for leading and/or aligning both elements in a predefined plug-in position.

A further advantage arises if a spacer which extends radially in the axial direction, projects radially from the outer surface and separates two windings or two sections of a winding from one another, already exists on at least one outer surface of the housing. Insulation, as would usually have to be additionally provided, is done away with by way of this integration of the spacer on the housing. Thereby, in a further integration step, the projections and recesses may be part of the spacer. By way of this, this not only accomplishes the function of insulation but at the same time also the function of a plug-in connection. In total, a housing arises, which is highly functional and at the same time is simply constructed and easily manufacturable.

Moreover, it is preferable if one outer surface of the housing comprises at least one clamping element for fastening a wire of the winding. With this, the incorporation of the winding is very significantly simplified, which permits a particularly quick and simple manufacture of the coil. In the clamping element, the winding wire may be fixed on the housing. A robust protection with regard to mechanical influences as well as a particularly good cooling may be achieved if the housing is preferably embedded into a cast mass.

The invention moreover relates to a pump assembly with an electric drive motor, in which at least one suppression coil according to the previous description is arranged. In particular with regard to this pump assembly, it may be the case of a submersible pump assembly. With the pump assemblies, it is known to cast out the stator housing and/or an electronics housing in which electronic components for the control of the motor are arranged, with a cast mass, in order to prevent a penetration of moisture into this region. With the casting-out of this region, there exists the problem that the coil core of a suppression coil is subjected to undesirable pressure forces. This is prevented by the housing according to the present description and which is provided according to the invention. The housing in particular is designed in such a tight or sealed manner, that a penetration of the cast mass into the inside of the housing is prevented, so that a coil core in the inside of the housing is kept free of forces which are caused by the pressure of the casting mass.

The present invention is hereinafter explained in more detail by way of one embodiment example with reference to the accompanying figures. The same or equally acting parts are provided with the same reference numerals. Not all of these equal or equally acting parts are accordingly provided with reference numerals, for reasons of a better overview. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

FIG. 1 is a perspective view obliquely from above, onto a submersible pump with a suppression coil according to the invention;

FIG. 2 is an exploded view of the housing and of the coil core of the suppression coil of FIG. 1;

FIG. 3 is a perspective view obliquely from above, onto the assembled housing of FIG. 2; and

FIG. 4 is a perspective view obliquely from above, onto the housing of FIG. 3 with a winding fastened thereon.

### DESCRIPTION OF THE PREFERRED EMBODIMENTS

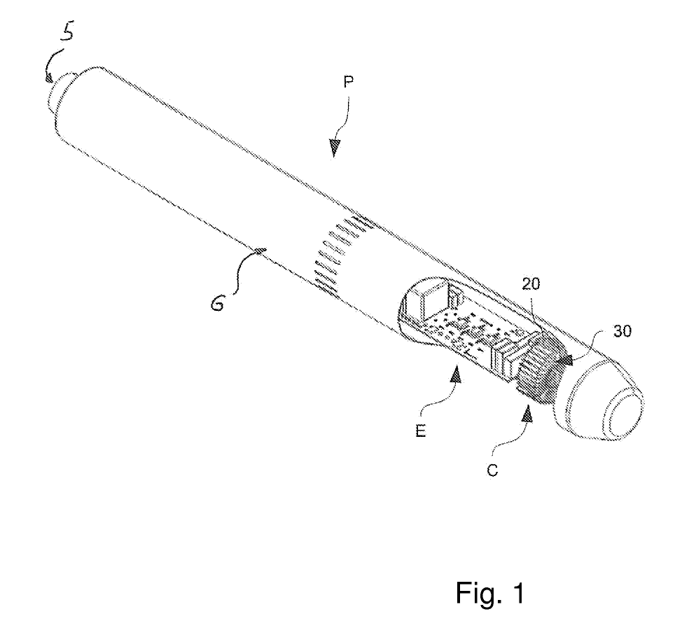

Referring to the drawings in particular, FIG. 1 shows a perspective view obliquely from above, onto a submersible pump P with a suppression coil C according to the invention. This is arranged at the lower end of the pump P behind the electronics E in mains supply to a drive motor in the inside of the pump housing G. However, it is to be understood that the suppression coil C could also be arranged at another position in the inside of the pump housing G. A pump stage is arranged in the inside of the pump housing G next to the drive motor and is driven by the drive motor and sucks the fluid via lateral slots of the pump P and ejects it at the upper end 5 of the pump P. The suppression coil C consists thereby of an annular coil core 10 (not visible) which is provided with windings 20 which in turn run around a housing 30, in which the coil core 10 is received.

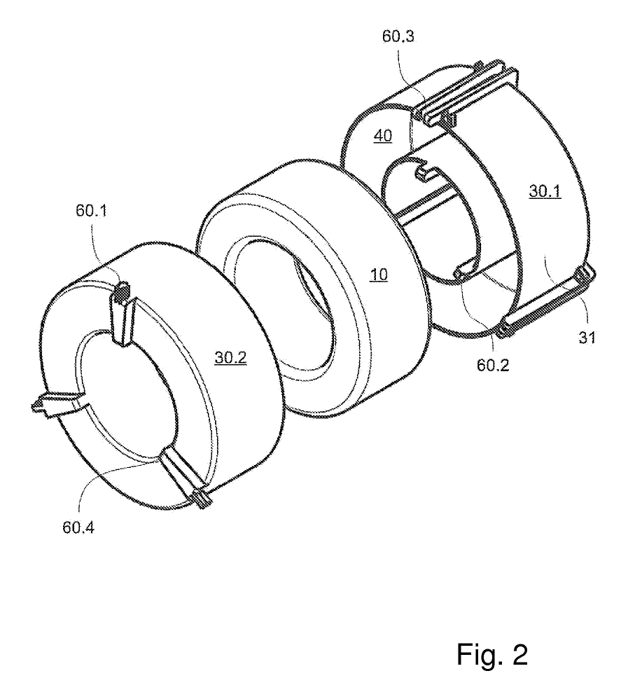

FIG. 2 shows an exploded view of the housing 30 and of the coil core 10 of the suppression coil C of FIG. 1. The core 10 consists of a magnetic material e.g. ferrite. Two shell bodies 30.1 and 30.2 of plastic are designed and dimensioned such that they form an annular cavity 40 in an assembled condition, in which cavity the core 10 is accommodated. Thereby, an air gap may remain between the core 10 and the inner surfaces of the shell bodies 30.1 and 30.2 and this air gap accommodates possible deformations of the shell bodies 30.1 and 30.2. The core 10 with this is protected from external loads in a simple way and manner, by which means an undesired change of its magnetic characteristics, thus the occurrence of the Villari effect, is ruled out. The shell bodies 30.1 and 30.2 are manufactured of an electrically non-conductive material and have a thickness which creates the necessary electrical insulation between the winding 20 and the core 10 as well as ensures the desired inherently stable characteristics.

Projections 60.1 and 60.2 which may be inserted into the complementary recesses or engagements 60.3 and 60.4 are formed on the shell bodies 30.1 and 30.2 for the simple connection of these. A safeguarding of the shell bodies 30.1 and 30.2 from deformation under mechanical load in a defined insertion position is achieved by way of this. In the assembled condition, the peripheral surfaces of the shell bodies 30.1 and 30.2 which overlap one another thereby form a common, particularly strong outer wall of the housing 30 which withstands high mechanical loads and securely rules out a Villari effect.

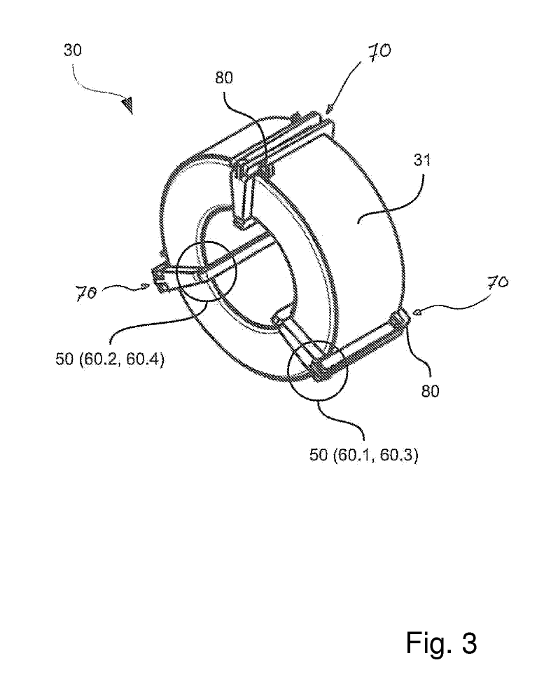

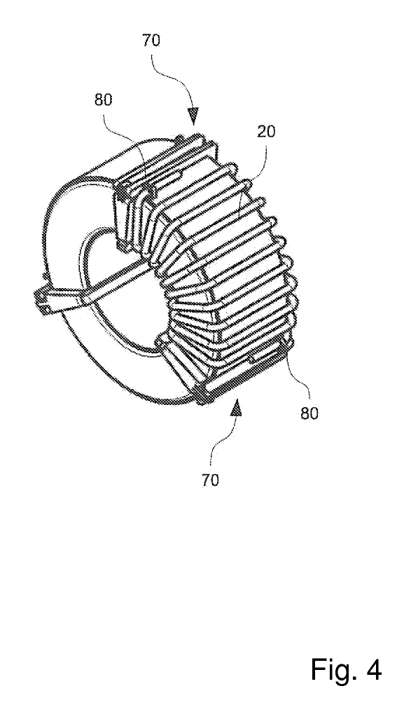

FIGS. 3 and 4 show perspective views of the assembled housing 30 of FIG. 2 obliquely from above, in which housing the coil core 10 is accommodated. Three spacers 70 are formed on an outer surface 31 of the housing 30 and these secure the necessary distance and the necessary creep length between individual windings 20, in order to create an electric insulation between these. It is further evident from this figure, that the projections 60.1 and 60.3 and the recesses 60.2 and 60.4 are designed integrated with the spacers, by which means these achieve a space-saving and at the same time easily creatable double function. The projections 60.1 and 60.3 with the recesses 60.2 and 60.4, form suitable plug-in connections which secure the shell bodies 30.1 and 30.2 against deformation under mechanical load. These connections 50 may thereby also be designed as a locking connection which securely rules out an opening of the housing 30 formed in such a manner, in the axial direction under mechanical load.

FIG. 4 shows a perspective view obliquely form above, onto the housing 30 of FIG. 3, with a winding 20 of in total three phases which is wound therein, wherein only one winding is represented. Clamping elements 80 which serve for fixing the wires, are formed on the outer surface 31 of the housing 30 for fastening the winding 20. Thereby, the winding 20 is in particular easily and quickly fixed to the housing 30.

In total, a suppression coil C arises, which withstands the high pressures, without losing its characteristics. This is particularly important since the inner space of the pump housing G, in which the electronics E and the coil core 10 are arranged, is cast out with a cast mass. This cast mass effects a certain pressure in the inside of the housing G, which is kept away from the coil core 10 by way of the housing 30 of the suppression coil C. Although the present invention was explained in detail with regard to a submersible pump, it is in no way limited to this, but may in principle be used wherever it is the case of a coil whose characteristics should also remain unchanged under high mechanical loads and which should be able to be manufactured in a simultaneously simple and inexpensive manner. The advantages according to the invention are also to be observed with these. The adaptation of the coil and in particular the specific design of the housing which is necessary in each case, belongs to the scope of the knowledge and ability of the man skilled in the art.

While specific embodiments of the invention have been shown and described in detail to illustrate the application of the principles of the invention, it will be understood that the invention may be embodied otherwise without departing from such principles.

What is claimed is:

1. A suppression coil comprising:
an annular coil core of a magnetic material;
at least one winding wound around the coil core; and
an annular inherently stable housing defining an annular inside, the coil core being arranged in the inside of the annular inherently stable housing.

2. A suppression coil according to claim 1, wherein the at least one winding is wound on an outside around the annular inherently stable housing.

3. A suppression coil according to claim 1, wherein the annular inherently stable housing is manufactured of an electrically insulating material.

4. A suppression coil according to claim 1, wherein the annular inherently stable housing is designed in a closed manner.

5. A suppression coil according to claim 1, wherein the annular inherently stable housing is composed of two shell bodies which are connected to one another and which are designed and dimensioned such that the two shell bodies enclose the annular inside to form a cavity in which the annular coil core is arranged.

6. A suppression coil according to claim 5, further comprising a plug-in connection wherein the shell bodies are connected to one another via the plug-in connection.

7. A suppression coil according to claim 5, wherein at least one of the shell bodies has a cylindrical side wall which surrounds the coil core on an inner periphery or an outer periphery, as well as a base extending transversely to the side wall, on an axial end of the side wall.

8. A suppression coil according to claim 7, wherein at least one of the shell bodies is designed in an annular manner with two cylindrical side walls radially distanced to one another and with an annular base connecting the two side walls at an axial end, wherein the cavity, in which the coil core is arranged, is formed between the side walls.

9. A suppression coil according to claim 7, wherein each of the two shell bodies has a cylindrical side wall to provide two side walls that overlap one another on one side of the coil core.

10. A suppression coil according to claim 5, wherein the shell bodies comprise projections and recesses which are complementary to one another, for guiding and/or aligning the two shell bodies into a predefined plug-in position.

11. A suppression coil according to claim 1, further comprising a spacer formed on an outer surface of the annular inherently stable housing, the spacer extending in an axial direction and projecting radially from the outer surface and separating two windings or two sections of the at least one winding from one another.

12. A suppression coil according to claim 10, wherein the projections and recesses are part of a spacer formed on an outer surface of the annular inherently stable housing, the spacer extending in an axial direction and projecting radially from the outer surface and separating two windings or two sections of the at least one winding from one another.

13. A suppression coil according to claim 1, wherein an outer surface of said annular inherently stable housing comprises at least one clamping element for fastening a wire of the winding.

14. A suppression coil according to claim 1, wherein the annular inherently stable housing is embedded into a cast mass.

15. A suppression coil according to claim 1, wherein the annular inherently stable housing is manufactured of an electrically insulating plastic material.

16. A pump assembly comprising an electrical drive motor comprising a suppression coil, the suppression coil comprising:
an annular coil core of a magnetic material;
at least one winding wound around the coil core; and
an annular inherently stable housing defining an annular inside, the coil core being arranged in the inside of the annular inherently stable housing.

17. A pump assembly according to claim 16, wherein the at least one winding is wound on an outside around the annular inherently stable housing.

18. A pump assembly according to claim 16, wherein the annular inherently stable housing is manufactured of an electrically insulating plastic material.

19. A pump assembly according to claim 16, wherein the annular inherently stable housing is composed of two shell bodies which are connected to one another and which are dimensioned such that the two shell bodies enclose the an annular inside to form a cavity in which the annular coil core is arranged.

20. A pump assembly according to claim 19, wherein at least one of the shell bodies comprises two cylindrical side walls radially distanced to one another and with an annular base connecting the two side walls.
